(19) United States
(12) Patent Application Publication
(10) Pub. No.: US 2006/0243105 A1
(43) Pub. Date: Nov. 2, 2006

(54) Electric hand tool

(76) Inventors: Stefano Delfini, Bettlach (CH); Hans Kaiser, Leuzigen (CH); Beat Gerber, Utzenstorf (DE); Charles Degutis, Neuhofen (DE)

Correspondence Address: Striker Striker & Stenby, 103 East Neck Road, Huntington, NY, 11743, US

(21) Appl. No.: 10/558,963

(22) PCT Filed: Mar. 4, 2005
(86) PCT No.: PCT/EP05/50987

§ 371 Date: Dec. 1, 2005

(30) Foreign Application Priority Data
Apr. 8, 2004 (DE) 102004017384.2

(51) Int. Cl. B25B 27/00

(52) U.S. Cl. 81/488

(57) ABSTRACT

An electric power tool (10) having a housing (12) from which a power cable (22) leads, is safer for the user because the circumference of the power cable (22) has lighting means (21, 26, 28, 30) along its longitudinal span, whose light makes the power cable (22) easily visible to the human eye in the dark.

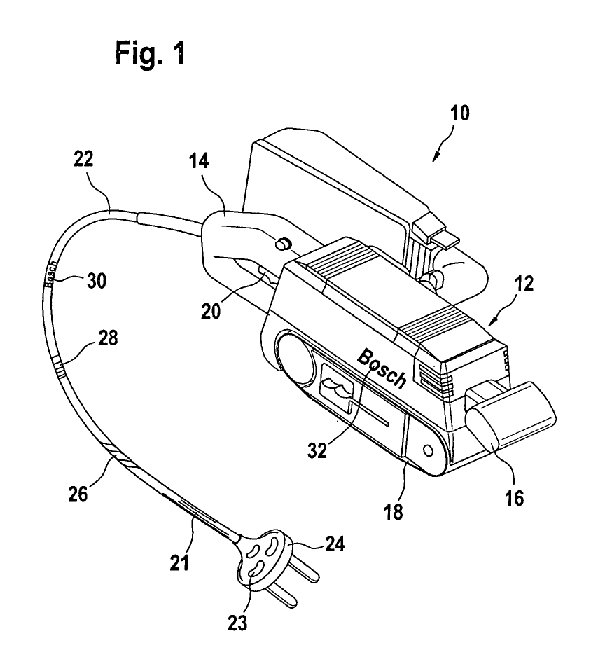

### PRIOR ART

The present invention is based on an electric power tool according to the preamble to claim 1.

The cables and plugs of the known electric power tools are difficult to see in the dark or under poor lighting conditions. There is therefore the danger of a user tripping over the unseen cable and being injured.

### ADVANTAGES OF THE INVENTION

The present invention, with the defining characteristics of claim 1, has the advantage that the power cables of power tools can be seen even under poor lighting conditions, thus reducing the danger of injury to the user. For example, when a short circuit occurs at the power connection of the power tool and the lights go out at the same time, such as when an electrical supply line is inadvertently drilled into, the danger of accident is significantly reduced.

Because the lighting means give off light themselves as a result of previous incident light, this eliminates the manufacturing expense of providing an external energy source, for example a power cable or battery and corresponding supply lines, and eliminates the energy cost to the power tool user of producing the lighting action.

Because the lighting means only emit light when the power cable is connected to an outlet or active voltage supply, they cannot light up unintentionally.

Because the lighting means are embodied as points and/or as straight or spiral longitudinal lines and/or as regularly or irregularly discontinuous, more or less wide rings or symbols, this significantly improves the recognizability of different devices in the dark and offers a wide range of optional graphic designs for the lighting effect.

Because the lighting means light up intermittently at determinable intervals, the lighting action can be selectively adjusted and a particular signaling effect can be achieved in the electric lines or on the power tool housing.

Because the lighting means reproduce graphic structures, in particular writing, operating instructions or advertising messages can also be displayed in the dark.

Because a plug at the end of the power cable is provided with lighting means, this plug is particularly easy to find in the dark and can itself serve to illuminate the background in the dark, for example in order to find an outlet in the dark.

Because the housing of the power tool is provided with lighting means in at least some regions, in particular self-luminous lighting means, it is also easy to find the power tool itself in the dark.

### DRAWINGS

An exemplary embodiment of the invention will be explained in detail below in conjunction with the accompanying drawing, which depicts an electric power tool according to the invention.

### EXEMPLARY EMBODIMENT

An electric power tool 10 embodied in the form of a hand planer is comprised of a housing 12 with a handle 14 protruding from the rear and with an auxiliary handle 16 at the front. Toward the bottom in the drawing, a revolving grinding belt 18 is provided, which is used for grinding work pieces.

The handle 14 has an on-off button 20 for switching on and off an electric motor, not shown, contained in the housing for driving the grinding belt 18. A power cable 22 protrudes from the rear end of the handle 14 and has a plug 24 at its end to supply power to the electric motor.

On the circumference of the power cable 22, longitudinal lines 21, a spiral ring structure 26, rings 28 of varying widths, and letters 30 are visible, which can be provided mixed on a single power cable or can each be provided on a separate power cable. Like the illuminated numbers or hands of wristwatches, these are comprised of a self-luminous, phosphorescent substance so that they light up in the dark all by themselves and/or assisted by another light source such as lamps or diodes.

This substance can also optionally be embodied so that it only lights up when the power cable 22 is connected to a power source, i.e. the plug 24 is plugged into an active outlet, or so that it fluoresces when a lighting source is switched to make this occur.

The lighting means structures 21, 26, 28, 30 can also be coupled via a control cable, not shown, which is situated in the outer insulation of the power cable 22, to a power supply unit, not shown, that is able to control the lighting action of the structures 21, 26, 28, 30. This permits the intensity of the brightness to be controlled; but it is also possible to use more or less regular interruption intervals to change the signaling action of the lights.

The housing 12 of the electric power tool 10 has an inscription 32 on both sides, indicating a manufacturer or company logo comprised of illuminated letters, whose lighting action improves the recognizability of the electric power tool 10 in the dark.

What is claimed is:

1. An electric power tool having a housing (12) from which a power cable (22) leads,
wherein the circumference of the power cable (22) has lighting means (21, 23, 26, 28, 30) along its longitudinal span, whose light makes the power cable (22) easily visible to the human eye in the dark.

2. The electric power tool as recited in claim 1,
wherein the lighting means (21, 23, 26, 28, 30) emit light fluorescently or phosphorescently in particular by means of previous incident light or are combined with another light source such as lamps or diodes.

3. The electric power tool as recited in claim 1,
wherein the lighting means (21, 23, 26, 28, 30) only emit light when the power cable (22) is connected to an outlet.

4. The electric power tool as recited in claim 1,
wherein the lighting means (23, 24, 26, 28, 30) light up intermittently, in particular at intervals determinable by the user.

5. The electric power tool as recited in claim 1,
wherein the lighting means are embodied as points (23) and/or as straight or spiral longitudinal lines (21, 26) and/or as regularly or irregularly discontinuous, more or less wide rings (28).

6. The electric power tool as recited in claim 1,
wherein the lighting means (21, 23, 24, 26, 28, 30) reproduce graphic structures 30 such as letters or the like or symbols such as a smiley face.

7. The electric power tool as recited in claim 1,
wherein a plug (24) at the end of the power cable (22) is provided with lighting means (23) that cover a large area of its surface, preferably its entire surface.

8. The electric power tool as recited in claim 1,
wherein at least some regions of the housing (12) are provided with lighting means (32), in particular self-luminous lighting means.

9. The electric power tool as recited in claim 1,
wherein the light intensity of the lighting means (21, 23, 24, 26, 28, 30, 32) is adjustable.
